(19) United States
(12) Patent Application Publication
(10) Pub. No.: US 2021/0040716 A1
(43) Pub. Date: Feb. 11, 2021

(54) SINGLE BAR CLOG PREVENTION DRAINAGE SYSTEM

(71) Applicants: Dennis Renesto, SR., Hialeah Gardens, FL (US); Dennis Renesto, JR., Hialeah Gardens, FL (US)

(72) Inventors: Dennis Renesto, SR., Hialeah Gardens, FL (US); Dennis Renesto, JR., Hialeah Gardens, FL (US)

(21) Appl. No.: 16/988,404

(22) Filed: Aug. 7, 2020

Related U.S. Application Data
(60) Provisional application No. 62/884,134, filed on Aug. 7, 2019.

(51) Int. Cl. E03C 1/262; B08B 17/02

(52) U.S. Cl. CPC E03C 1/262; B08B 17/02

(57) ABSTRACT

The single bar clog prevention drainage system is a novel drain system that reduces the likelihood of clogs occurring by increasing the amount of space in the circular drain and using a single bar system within the drain to secure a drain stopper, thereby allowing hair and other debris to easily pass through the drain without creating clogs. The increased space in the circular drain eliminates the need to use snakes, harsh chemicals, or any of the other products and methods commonly used to clear a drain, saving the user both time and effort when dealing with bathtub drainage systems.

### CROSS-REFERENCE TO RELATED APPLICATION

The present application is related to and claims priority from prior provisional application Ser. No. 62/884,134, filed Aug. 7, 2019, the entire application of which is incorporated herein by reference.

### COPYRIGHT NOTICE

A portion of the disclosure of this patent document contains material that is subject to copyright protection. The copyright owner has no objection to the facsimile reproduction by anyone of the patent document or the patent disclosure, as it appears in the Patent and Trademark Office patent file or records, but otherwise reserves all copyright rights whatsoever. 37 CFR 1.71(d).

### BACKGROUND OF THE INVENTION

The following includes information that may be useful in understanding the present invention(s). It is not an admission that any of the information provided herein is prior art, or material, to the presently described or claimed inventions, or that any publication or document that is specifically or implicitly referenced is prior art.

### 1. FIELD OF THE INVENTION

The present invention relates generally to the field of drainage systems. More specifically, the invention is single bar clog prevention drainage system that prevents clogging from occurring in bathtub and shower drains.

### 2. DESCRIPTION OF THE RELATED ART

Currently available drains usually have several bars within the circular portion of the drain that connect to a center location that controls the stopper. These bars often catch hair or other debris, causing clogs in the narrow circular section of the drain. Unclogging a drain can be a frustrating and time-consuming activity. Hair, food, and other debris can cause backups in plumbing, forcing homeowners to call a plumber to clear the drain, which result in an expensive bill. Alternately, chemicals may be used to attempt to dissolve the clog, however, such chemicals can harm the plumbing system, particularly any rubber seals.

Ideally, a single bar clog prevention drainage system should provide a drain system that helps prevent clogs from occurring and, yet would operate reliably and be manufactured at a modest expense. Thus, a need exists for a reliable single bar clog prevention drainage system to avoid the above-mentioned problems.

### BRIEF SUMMARY OF THE INVENTION

In view of the foregoing disadvantages inherent in the known drainage art, the present invention provides a novel single bar clog prevention drainage system. The general purpose of the present invention, which will be described subsequently in greater detail is to provide a drain with expanded space in the circular drain and a single bar, allowing debris to pass through the drain without creating clogs.

The single bar clog prevention drainage system is a novel drain system capable of reducing the likelihood of clogs occurring by increasing the amount of space in the circular drain, thereby allowing hair and other debris to easily pass through the drain without creating clogs. The presently claimed invention uses a single bar system within the drain to secure a drain stopper, while allowing water and debris to flow freely through the plumbing. The increased space in the circular drain eliminates the need to use snakes, harsh chemicals, or any of the other products and methods commonly used to clear a drain, saving the user both time and effort when dealing with bathtub drainage systems.

The present invention holds significant improvements and serves as a single bar clog prevention drainage system. For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein. The features of the invention that are believed to be novel are particularly pointed out and distinctly claimed in the concluding portion of the specification. These and other features, aspects, and advantages of the present invention will become better understood with reference to the following drawings and detailed description.

### BRIEF DESCRIPTION OF THE DRAWINGS

The figures that accompany the written portion of this specification illustrate embodiments and method(s) of use for the present invention, a single bar clog prevention drainage system, constructed and operative according to the teachings of the present invention.

FIG. 1 shows a perspective view illustrating a single bar drain according to an embodiment of the presently claimed invention.

FIG. 2A is a perspective view illustrating the stopper in an open position on the single bar drain, according to an embodiment of the presently claimed invention.

FIG. 2B is a perspective view illustrating the stopper in a closed position on the single bar drain, according to an embodiment of the presently claimed invention.

FIG. 3 is an expanded cut out view illustrating the single bar drain system installed in a bathtub, according to an embodiment of the presently claimed invention.

FIG. 4 is a perspective view illustrating the tool used to fit the single bar drain, according to an embodiment of the presently claimed invention.

FIG. 5 is a perspective view illustrating the stopper knob, according to an embodiment of the presently claimed invention.

The various embodiments of the present invention will hereinafter be described in conjunction with the appended drawings, wherein like designations denote like elements.

### DETAILED DESCRIPTION

As discussed above, embodiments of the present invention relate to a drainage system and more particularly to a single bar clog prevention drainage system as used to reduce the clogs in a bath tub or shower drain system caused by hair or other debris.

Generally speaking, the presently claimed invention is an improved drain system for bathtubs and showers. The drain system includes a stopper unit, a modified drain, and a specialized installation and removal tool. The drain unit includes a single bar capable of securing the stopper. The modified drain unit reduces the amount of bars in the drain, allowing for better flow of water and debris through the plumbing. The user can apply the special tool to install and remove the drain. The stopper can then be placed in the drain and secured. The drain operations normally when opened, as the reduced amount of bars increase water flow, thereby ensuring the drain operates normally.

Referring to the drawings by numerals of reference there is shown in FIG. 1, a drain unit 1 includes a single bar 2 that is capable of securing the stopper 3. The single bar 2 is located within the circular portion 4 of the drain unit 1, where it attaches to the wall of the circular portion 4 in one place and allows for better flow of water and debris through the drain by having only one surface for hair and other debris to catch on. The single bar 2 has a threaded hole 5 at the end of the bar 2 that is positioned in the center of the circular portion 4 of the drain unit 1.

The circular portion 4 of the drain unit 1 preferably has a wider diameter than standard drain, to better allow debris and water to flow through. The drain unit 1 also has two receiving portions 6 set opposite each other in the circular portion 4 of the drain unit. The receiving portions 6 receive the installation tool 7 that is used to install and position the drain unit.

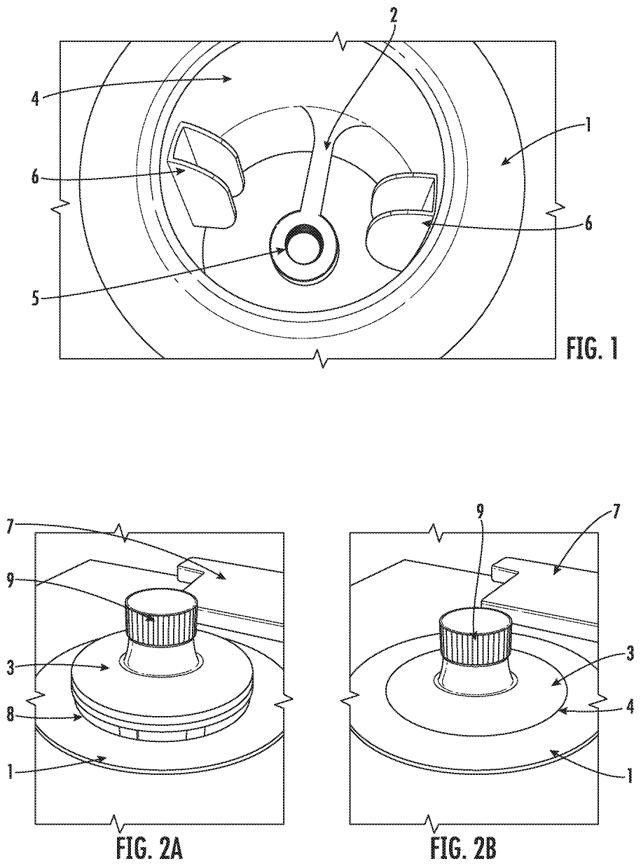

Referring now to FIGS. 2A-B, the stopper 3 can have two positions: open and closed. As shown in FIG. 2A, when the stopper 3 is in the open position, there is a gap 8 between the circumference of the stopper 3 and the circular portion 4 of the drain unit 1, allowing water to flow through the gap 8 into the drain. As shown in FIG. 2B, when the stopper 3 is in the closed position, the outer circumference of the stopper 3 fits snuggly against the circular portion 4 of the drain unit 1, leaving no gap for water to flow through. The stopper 3 has a handle 9 that a user can grip to raise and lower the stopper.

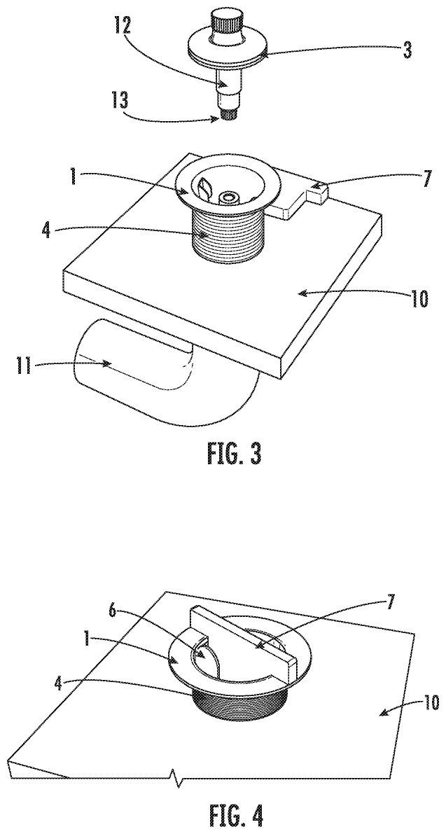

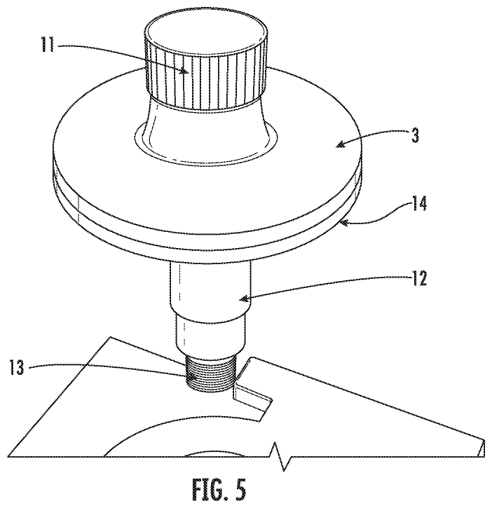

Referring now to FIG. 3, the drain unit 1 extends through the base 10 of a bathtub or shower so that the circular portion 4 connections to the plumbing pipes 11. As shown in FIGS. 3 and 5, the stopper 3 has a bolt 12 that extends out the base of the stopper 3 into the circular portion 4 of the drain unit 1. The bolt 12 has a threaded end 13 that screws into the threaded hole 5 in the end of the single bar 2, holding the stopper 3 in place. The stopper 3 also has a rubber seal 14 that runs along the outer circumference of the stopper 3 on the underside, and creates a secure seal with the circular portion 4 of the drain unit 1.

Referring now to FIG. 4, the drain unit 1 can be installed, uninstalled, and repositioned by slotting the installation tool 7 into the receiving slots 6 and turning the drain unit 1 via the installation tool 7.

The embodiments of the invention described herein are exemplary and numerous modifications, variations and rearrangements can be readily envisioned to achieve substantially equivalent results, all of which are intended to be embraced within the spirit and scope of the invention. Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application.

What is claimed is new and desired to be protected by Letters Patent is set forth in the appended claims:

1. A single bar clog prevention drainage system comprising:
a. a drain unit having
i. a circular portion with vertical walls;
ii. a single bar extending perpendicularly from a part of the vertical walls of the circular portion at a first end and having a threaded hole at a second end;
iii. a first receiving slot extending from a part of the vertical walls of the circular portion; and
iv. a second receiving slot extending from a part of the vertical walls of the circular portion directly opposite the first receiving slot; and
b. a stopper having
i. a circular base having the same diameter at the circular portion of the drain unit so that the stopper fits snuggly against the vertical walls of the circular portion;
ii. a handle;
iii. a bolt with a threaded end, wherein the threaded end is screwable into the threaded hole at the second end of the single bar; and
iv. a rubber seal extending along a circumference of the circular base.

2. A single bar clog prevention drainage system kit comprising:
a. a single bar clog prevention drainage system according to claim 1; and
b. an installation tool,
wherein the installation tool slots into the first receiving slot and the second receiving slot, and
wherein a grip portion of the installation tool extends above the drain unit when the installation tool is slotted into the first receiving slot and the second receiving slot.

3. The single bar clog prevention drainage system according to claim 1, wherein the stopper is securable to the single bar in an open position and a closed position, wherein, in the open position, there is a gap between the stopper and the drain unit, and wherein, in the closed position, the stopper is flush with the circular portion of the drain unit.
